(19) United States
(12) Patent Application Publication
(10) Pub. No.: US 2017/0317899 A1
(43) Pub. Date: Nov. 2, 2017

(54) USING TRAFFIC DATA TO DETERMINE NETWORK TOPOLOGY

(71) Applicant: CA, Inc., New York, NY (US)

(72) Inventor: Joseph Elisha Taylor, Fort Collins, CO (US)

(21) Appl. No.: 15/141,943

(22) Filed: Apr. 29, 2016

(51) Int. Cl. H04L 12/26; H04L 29/08; H04L 29/12; H04L 12/931; H04L 12/24; H04L 12/28

(52) U.S. Cl. CPC H04L 43/062; H04L 69/325; H04L 69/324; H04L 12/2854; H04L 49/355; H04L 41/0631; H04L 61/6068

(57) ABSTRACT

A network topology may be determined based on flow data exported from a network. A topology generator analyzes flow data and determines a topology based on devices and connections between the devices indicated in the flow data. The topology generator may also infer types of the devices based on communication protocols and port numbers used by the devices. The topology generator may continually update the topology as additional flow data is exported from devices in the network and analyzed. As a result, the topology reflects a current status of devices in the network based on the communications indicated in the additional flow data. The topology generator may also retrieve flow data from a specified time period or flow data related to a specified device to generate topologies that are targeted for analysis or troubleshooting of a particular network issue.

### BACKGROUND

The disclosure generally relates to the field of computer systems, and more particularly to generating network topologies.

Network devices, such as routers or switches, can capture data which indicates the flow of network traffic. For example, one or more intervening routers can capture flow data that indicates network traffic between two hosts. The flow data can include information such as source and destination Internet Protocol (“IP”) addresses, source and destination ports, Layer 3 protocol type, number of packets, number of bytes per packet, autonomous system (AS) numbers of the source or destination, subnet addresses, etc. The network devices periodically export the captured flow data to flow data collectors and software applications for analysis and troubleshooting of network issues.

Network topology may also be used to troubleshoot network issues. Network topology depicts interconnections among devices in a network or across multiple networks. A network topology may be manually created and maintained as devices are added or removed from a network. Alternatively, a network topology may be determined algorithmically by polling and gathering information from each device in a network using the Simple Network Management Protocol (SNMP).

### BRIEF DESCRIPTION OF THE DRAWINGS

Embodiments of the disclosure may be better understood by referencing the accompanying drawings.

FIG. 1 depicts an example network with devices that export flow data to a topology generator.

FIG. 2 depicts a flow diagram of example operations for determining a network topology based on flow data.

FIG. 3 depicts a flow diagram of example operations for updating a network topology based on flow data.

FIG. 4 depicts example topologies generated based on filtered flow data.

FIG. 5 depicts an example computer system with a topology generator.

### DESCRIPTION

The description that follows includes example systems, methods, techniques, and program flows that embody aspects of the disclosure. However, it is understood that this disclosure may be practiced without these specific details. For instance, this disclosure refers to flow data that is captured based on transport layer protocols in illustrative examples. But aspects of this disclosure can be applied to flow data captured based on application layer protocols, such as Hypertext Transfer Protocol (HTTP), or flow data captured based on data link layer (Layer 2) protocols, such as those captured in sFlow data. In other instances, well-known instruction instances, protocols, structures and techniques have not been shown in detail in order not to obfuscate the description.

Terminology

The description below uses the term “flow data” or “network traffic data” to refer to data related to the flow of IP network traffic. A flow is a unidirectional sequence of packets that shares a set of values or properties such as ingress interface, source IP address, destination IP address, IP protocol, source port, destination port, etc. Network traffic can be packetized according to transport layer protocols (i.e. Layer 3 protocols) such as the Transmission Control Protocol (“TCP”) or the User Datagram Protocol (“UDP”). Network devices that implement transport layer protocols are capable of capturing flow data. Flow data can include a single flow record or may include multiple flow records. A flow record can include information such as source and destination IP addresses, source and destination ports, number of packets, number of bytes per packet, a timestamp for a flow's start time, a timestamp for a flow's finish time or duration, etc. Although the term “flow data” is used herein, other literature may refer to similar data as “NetFlow,” “Jflow,” “NetStream,” “AppFlow,” “Traffic Flow,” “Layer 3 data,” etc.

Overview

Automated discovery of network topology through SNMP polling can increase a load on a network as devices in the network are polled to retrieve topology information. Additionally, the load on the network is often not temporary as the devices are polled at regular intervals to keep the network topology updated with network changes. To avoid this additional load, a network topology may be determined based on flow data exported from a network. A topology generator analyzes flow data and determines a topology based on devices and connections between the devices indicated in the flow data. The topology generator may also infer types of the devices based on communication protocols and port numbers used by the devices. The topology generator may continually update the topology as additional flow data is exported from devices in the network and analyzed. As a result, the topology reflects a current status of devices in the network based on the communications indicated in the additional flow data. The topology generator may also retrieve flow data from a specified time period or flow data captured by a specified device to generate topologies that are targeted for specific issue analysis or troubleshooting. For example, the topology generator may retrieve flow data from a time period that corresponds to a time at which a network issue occurred and generate a topology that reflects active devices during the time period.

Example Illustrations

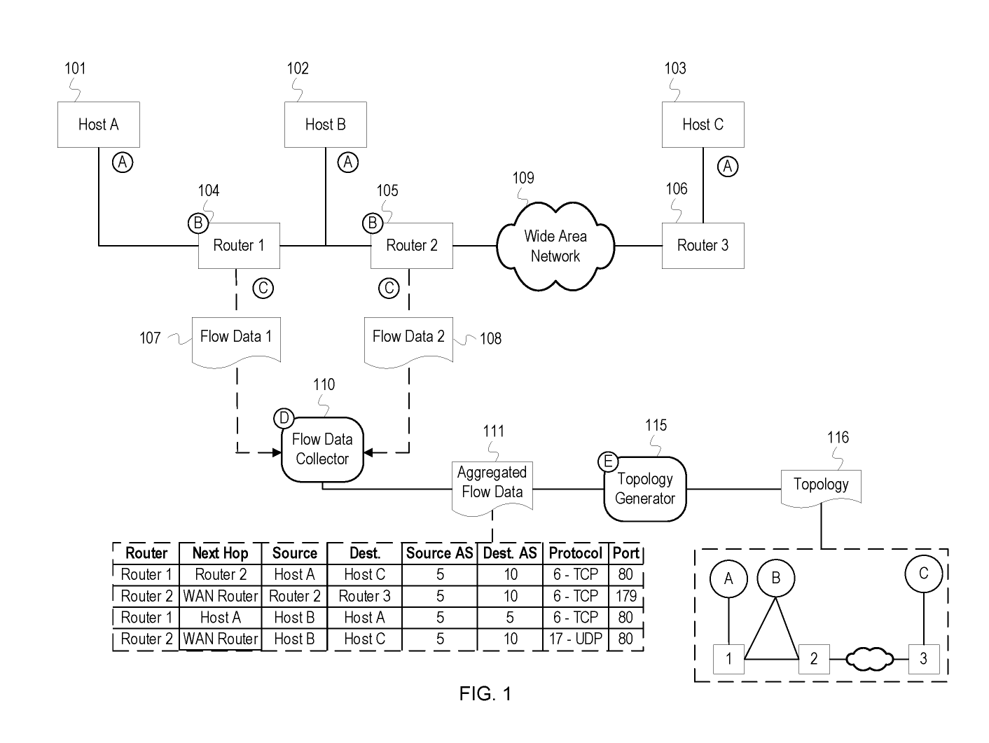

FIG. 1 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 1 depicts an example network with devices that export flow data to a topology generator. FIG. 1 depicts a host A 101, a host B 102, and a host C 103 that are communicatively coupled to a router 1 104, a router 2 105, and a router 3 106 (hereinafter “the routers”). The host C 103 communicates with the host A 101 and the host B 102 through a wide area network 109 (“network 109”). The router 1 104 and the router 2 105 communicate with a flow data collector 110.

At stage A, the host A 101, the host B 102, and the host C 103 communicate through the network 109, the router 1 104, the router 2 105, and the router 3 106. The network 109 is a wide area network, such as the Internet, that connects the router 2 105 with the router 3 106 and may include various networks and network devices, such as routers and switches, which enable the connection between the two routers. The routers may connect to the network 109 through other devices not depicted such as a switch or firewall. Additionally, in some implementations, the routers may be other network devices capable of capturing flow data, such as switches. The host A 101, the host B 102, and the host C 103 may be servers, databases, or computer systems that host applications, web resources, virtual machines, data, etc., or one or more of the hosts may be a computer workstation, mobile computing device, server, or other device capable of communicating through the network 109. The host A 101, the host B 102, and the host C 103 may communicate using various communication protocols such as HTTP and UDP. The network traffic generated by the host A 101, the host B 102, and the host C 103 flows through the routers. For example, network traffic between the host A 101 and the host B 102 flow through the router 1 104, and network traffic between the host C 103 and the host B 102 flow through the router 2 105 and the router 3 106.

At stage B, the router 1 104 and the router 2 105 capture flow data related to the network traffic generated by the host A 101, the host B 102, and the host C 103. While the host A 101, the host B 102, and the host C 103 can communicate using application layer protocols such as HTTP, the routers process the network traffic at the transport layer (Layer 3 of the Internet Protocol Suite). Packets form the network traffic. The routers capture data related to individual network traffic packets to create flow data. The flow data collected by the routers can include information such as source and destination IP addresses, number of packets, number of bytes per packet, etc. The routers may capture the flow data from an ingress or egress IP interface, i.e. as the network traffic flows into a router or as the network traffic flows out of a router. The routers may not capture flow data for each packet that is received. For instance, routers may limit packets captured due to processing constraints or to limit the overall amount of flow data captured. Instead, the routers may sample one out of every n packets or determine a sample rate or sample frequency based on some other configuration. For example, the routers may use random sampling or adjust the sample rate based on network traffic volume.

At stage C, the router 1 104 and the router 2 105 export flow data 1 107 and flow data 2 108, respectively, to the flow data collector 110. The router 3 106 does not export flow data to the flow data collector 110, but in some implementations, the router 3 106 may export flow data to another flow data collector (not depicted). The flow data collector 110 may be an application running on a server and may communicate with the routers through the wide area network 109, a local network, or the Internet. The routers may export flow data to the flow data collector 110 using communication protocols such as UDP or Stream Control Transmission Protocol (SCTP). The timing or frequency with which the routers export the flow data can vary. For example, the routers may be configured to export flow data after the expiration of a time interval. In some implementations, the routers may export flow data after network traffic has not been received for a threshold time interval or after a TCP session terminates indicating the end of a conversation between network devices. The routers may export the flow data synchronously or independently in accordance with their individual configurations. Although depicted as exporting the flow data directly to the flow data collector 110, the routers may export flow data through a series of flow data collectors or harvesters (not depicted). The flow data collectors or harvesters then relay the flow data received from the routers to the flow data collector 110. Additionally, the routers may export flow data to a database that is accessed as needed by the flow data collector 110 or the topology generator 115.

The flow data 1 107 includes flow data for communications between the host A 101 and the host B 102 and communications between the host A 101 and the host C 103. The flow data 2 108 includes flow data for communications between the host A 101 and the host C 103 and communications between the host B 102 and the host C 103. The flow data 2 108 does not include flow data for communications between the host A 101 and the host B 102 as that network traffic flows through the router 1 104. The flow data 1 107 and the flow data 2 108 also include router-to-router communications, such as communications between the router 2 105 and the router 3 106.

At stage D, the flow data collector 110 aggregates the flow data 1 107 and the flow data 2 108 to generated aggregated flow data 111. The aggregated flow data 111 includes identifiers for an exporting router, a source device and a destination device. The aggregated flow data 111 also includes a source AS, a destination AS, a protocol, and a port number. Although not depicted, the aggregated flow data 111 may also include a number of packets communicated, an amount of data communicated, a timestamp, a subnet address, etc. For simplicity, the router, source, and destination columns merely include the names of the components depicted in FIG. 1. In an actual implementation, the host A 101, for example, may be identified by its IP address in the Source or Destination columns.

The flow data collector 110 may limit aggregation of flow data to flow data captured by the routers within a time window. For example, the flow data collector 110 may only aggregate flow data captured within the last minute. The duration of the time window may be based on the frequency with which the routers export flow data. For example, if the routers export flow data every two minutes, the time window may be two minutes. Also, the time window may be based on an amount of flow data being captured. If a large amount of flow data is captured, the flow data collector 110 may shorten the time window so less data is aggregated at a time. After aggregating the flow data 1 107 and the flow data 2 108, the flow data collector 110 sends the aggregated flow data 111 to the topology generator 115.

At stage E, the topology generator 115 generates the topology 116 based on the aggregated flow data 111. The topology generator 115 analyzes the aggregated flow data 111 to identify relationships among entities in the network 109. The topology generator 115 may first analyze the aggregated flow data 111 to identify unique entities captured in the aggregated flow data 111. For example, the topology generator 115 may identify each of the routers and the hosts based on the fact that those entities appear as source and destination addresses and/or next hop addresses. The topology generator 115 may then analyze records in the aggregated flow data 111 for each unique entity to identify relationships for that entity. For example, the topology generator 115 may select the router 1 104 and analyze the first and third records in the aggregated flow data 111 to determine the router 1's 104 topological relationships or connections of the host A 101, the host B 102, and the router 2 105.

The topology generator 115 may determine device types based on a communication protocol indicated in a record of the aggregated flow data 111. Although FIG. 1 indicates devices types in the aggregated flow data 111 (e.g., host and router), flow data generally indicates an IP address which may not be descriptive of particular device type. As a result, the topology generator 115 utilizes communication protocols indicated in the flow data to infer device types associated with the IP addresses. In FIG. 1, the first record in the aggregated flow data 111 indicates that the source, the host A 101, and the destination, the host C 103, are communicating using the TCP protocol. Flow data typically includes a protocol number and not the name of the protocol as depicted for illustration purposes in the aggregated flow data 111. The topology generator 115 may determine that the TCP protocol is being used by looking up the protocol associated with the indicated protocol number in the protocol number list provided by the Internet Assigned Numbers Authority (IANA). In some instances, such as with the TCP protocol, the topology generator 115 is unable to infer a device type based on the protocol since multiple device types may use the same communication protocol. However, the topology generator 115 may infer a device type based on both the communication protocol and the port number used for communication. For example, TCP traffic on port 80 is typically Hypertext Transfer Protocol (HTTP) traffic which indicates a device such as a host, a web server, or an application server. As an additional example, TCP traffic on port 179 is typically Border Gateway Protocol (BGP) traffic which indicates a communication between two routers. A further example is UDP which is often used for video traffic and may indicate a web server that hosts and streams video files.

The topology generator 115 may also identify WAN traffic based on comparing source and destination AS numbers. In the first, second, and fourth records, the source and destination AS numbers are different which indicates WAN traffic. In the third record, the AS numbers are the same which indicates local network traffic. Using the AS numbers, the topology generator 115 determines that the host A 101, the host B 102, the router 1 104, and the router 2 105 belong to the same network (indicated by AS number 5) and that the host C 103, and the router 3 106 belong to the a different network (indicated by AS number 10) that is accessible through the wide area network 109. The topology generator 115 may also identify WAN based on devices identified in the next hop field of the aggregated flow data 111. In FIG. 1, the second and fourth flow records in the aggregated flow data 111 indicate a next hop of “WAN router.” The WAN router is part of the wide area network 109. The WAN router may be a router that is maintained by a service provider that facilitates transmission of WAN traffic, such as an Internet service provider. As a result, the WAN router is not depicted since the WAN router is a device that is managed by the service provider. In some implementations, the topology generator 115 may indicate the WAN router in the topology 116 as part of the cloud that represents the WAN.

The generator may indicate the topology 116 using a graph data structure that consists of nodes and vertices. Each node in the graph data structure corresponds to a device indicated in the aggregated flow data 111. The vertices or edges of a graph node indicate relationships for the device. A node for the host A 101, as depicted in the topology 116, has a single edge that connects the node to a node for the router 1 104. Similarly, a node for the router 1 104 has three edges: one to the host A 101, one to the host B 102, and one to the router 2 105. Additionally, elements of the topology 116 such as WAN traffic or unknown elements may be indicated with a node in the graph data structure. The nodes and edges may be labeled and include attribute information. For example, each node may be labeled with/identified by an IP address and may include attribute information such as device type, amount of traffic generated or received, AS number, subnet address, etc. The attribute information may be used to display the topology 116 in a graphical user interface (GUI). For example, an application that generates and causes the GUI for the topology 116 to be displayed may associate a different image or graphic with particular device types. In FIG. 1, the hosts are indicated with circles, the routers are indicated with squares, and the WAN traffic is indicated with a cloud. In some implementations, the characteristics of the graphics or images used to display the devices and connections in the topology 116, such as color, transparency, size, etc., may be modified based on attribute information. For example, devices that generate a high amount of traffic may be associated with the color red while devices that generate a low amount of traffic may be associated with the color blue.

The topology 116 may also be indicated in a similar manner using a Unified Modeling Language (UML), a markup language such as extensible markup language (XML), etc. For example, an XML file may be configured to include each device as an item in the file with tags for defining device relationships. The XML file may be parsed by an application to generate a graphical display of the topology 116.

In some implementations, the topology generator 115 may include a placeholder or graphic in the topology 116 that represents unknown devices or portions of a network. In FIG. 1, the topology generator 115 does not have access to flow data captured within the network to which the host C 103 and the router 3 106 belong. As a result, there may be devices in addition to the router 3 106 and the host C 103 of which the topology generator 115 is unaware. The topology generator 115 may add a placeholder for the unknown devices and may also indicate that the connections between the wide area network 109, the host C 103, and the router 3 106 are speculative (e.g. may include a question mark next to the connections or indicate the connections in a different color). The connections are speculative because there may be additional intervening devices that connect those devices.

After generating the topology 116, the topology generator 115 may supply the topology 116 to a user interface for display or to a network monitoring application for further analysis. The network monitoring application may use the topology 116 to perform root cause analysis, identify improper network connections, identify critical network devices, etc. For example, the topology 116 may be used to verify a network topology design to ensure that the devices in the network are connected and communicating as designed. As an additional example, the topology 116 may be used to identify critical devices such as devices that are single points of failure.

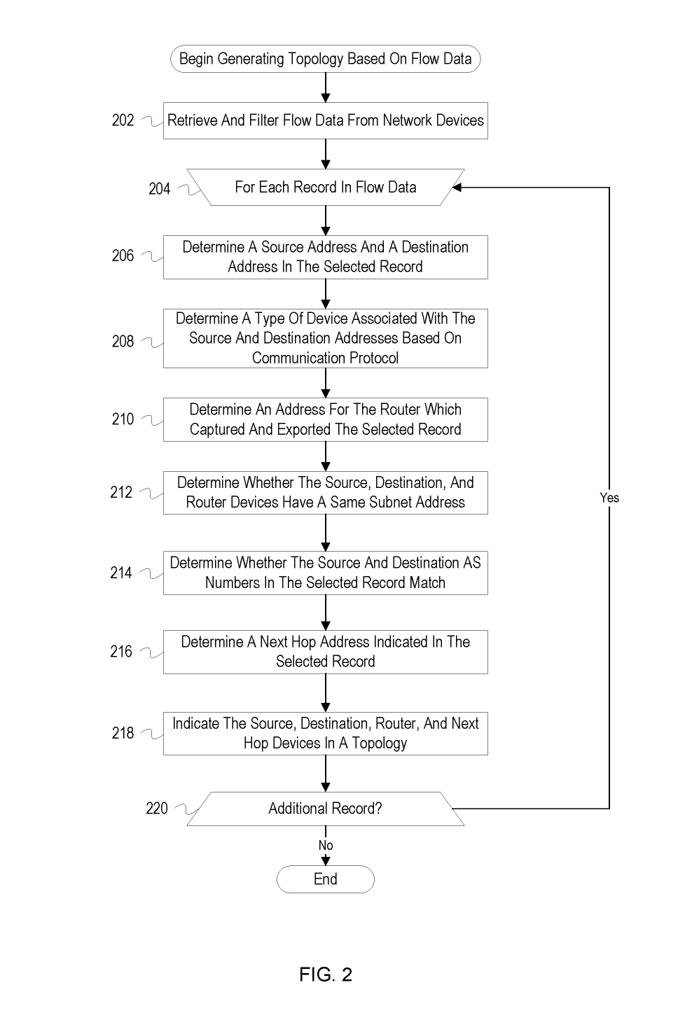

FIG. 2 depicts a flow diagram of example operations for determining a network topology based on flow data. FIG. 2 refers to a topology generator as performing the operations for each of reading and consistency with FIG. 1 even though identification of program code can vary by developer, language, platform, etc.

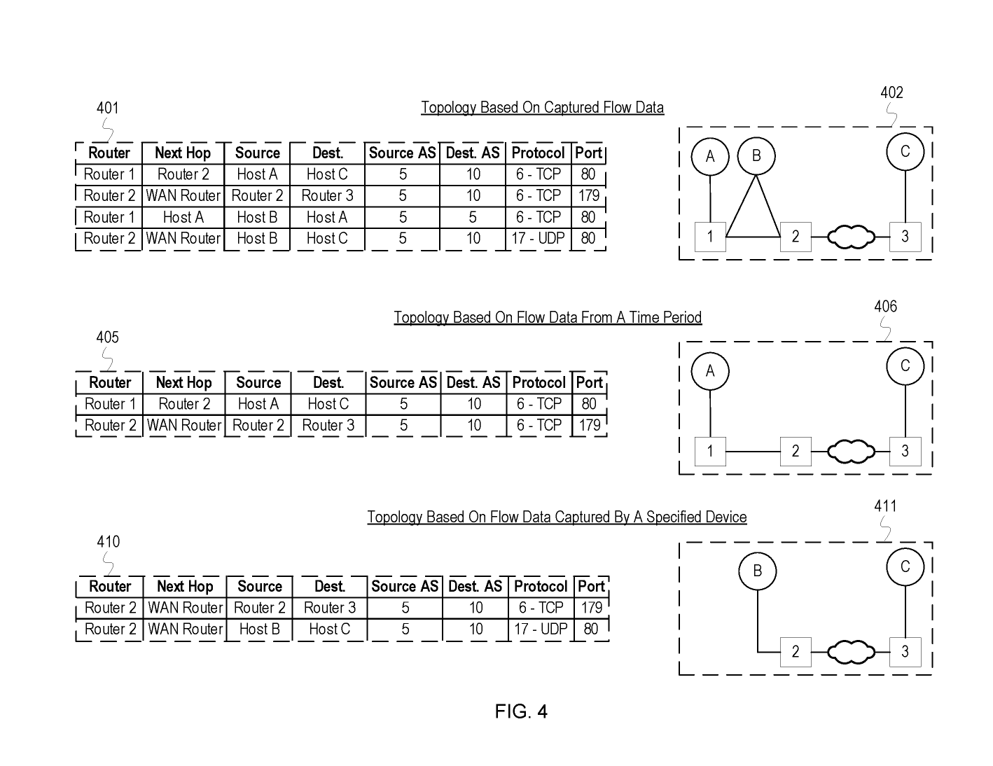

The topology generator (“generator”) retrieves and filters flow data from network devices (202). The generator may receive flow data directly from the network devices or may receive flow data through an intervening flow data collector. For example, multiple network devices within a network can export flow data to a flow data collector. The flow data collector then relays the flow data to the generator. The generator may store the flow data in a database or may load the received flow data into memory of a system running the generator. As described in additional detail in FIG. 4, the generator may also filter the flow data based on a time period or a specified device or devices. For example, the generator may identify records in the flow data related to devices within a specified AS. The generator may receive an indication of a time period or a specified device from a network management application. The time period may correspond to a time in which the network management application determined that a network issue occurred. Similarly, the specified device may correspond to a device that is related to or a cause of the network issue. The generator may use the filtered flow data to generate a topology as described in the operations below and then supply the topology to the network management application for analysis or troubleshooting.

The generator begins analyzing each record in the flow data to generate a topology based on the flow data (204). The generator iterates through each record in the flow data to determine relationships indicated by the record. The record currently being iterated over is hereinafter referred to as the “selected record.” In some implementations, the generator may first deduplicate the flow data records and remove duplicate records that indicate the same source and destination address. In other implementations, the generator may iterate through the flow data based on devices. For example, the generator may first identify each unique device indicated in the flow data, and then search the flow data with an identifier for the device to identify records which indicate topological relationships for the device.

The generator determines a source address and a destination address in the record (206) and determines a type of device associated with the source and destination addresses based on a communication protocol indicated in the selected record (208). The generator reads the IP addresses for the source and destination devices from the selected record; however, the IP addresses may not indicate a type of the source and destination devices. To infer a device type, the generator can also determine the communication protocol being used to communicate between the devices. For example, a web server typically communicates using HTTP. The generator identifies the protocol number in the selected record and determines the transport layer protocol associated with the number based on the IANA protocol list. For example, the protocol number 6 indicates TCP traffic, and the protocol number 8 indicates an exterior gateway protocol. Since some protocols may carry multiple types of traffic, the generator can use the source and destination ports to infer an application layer protocol. For example, TCP traffic that travels over port 80 is likely HTTP traffic, TCP traffic that travels over port 179 is likely BGP traffic, and TCP traffic on port 3260 is likely Internet Small Computer System Interface (iSCSI) traffic, etc. Once the communication protocols used by the devices are determined, the generator infers a device type. For example, BGP traffic indicates router-to-router communication, iSCSI traffic indicates communication with network attached storage system or device.

The generator determines an address for the router which captured and exported the selected record (210). The generator determines that the router which captured the flow data connects the source and the destination devices. As the traffic between the source and the destination devices flows through a network, the same traffic may be captured at multiple routers. By determining each router which captured the traffic in flow data, the routers located between the source and destination devices can be determined as additional flow data is analyzed.

The generator determines whether the source, destination, and router devices have the same subnet address as indicated in the selected record (212). The subnet address indicates to which part of a larger network a device belongs. As a result, the topology can reflect whether devices belong to a same subnet or different subnets. Additionally, based on the router's subnet address, the topology can indicate whether traffic flows through other subnets different from both the source and destination devices' subnets.

The generator determines whether the AS numbers in the selected record match (214). Similar to the subnet address, the AS numbers can indicate whether the source and destination devices belong to a same network. However, while a local network may have multiple subnets, different AS numbers indicate different networks that may communicate via WAN traffic. Indicating WAN traffic in the topology can allow an administrator to determine whether a service provider that facilitates the WAN traffic may be the cause of a network issue, as an administrator can determine that the flow of traffic traverses through a WAN.

The generator determines a next hop address indicated in the selected record (216). The next hop address indicates the next router or network device that will receive and route the traffic as it flows across a network. Similar to the router which captured and exported the selected record, the generator determines that the next hop router connects the source and the destination devices and is logically located between the exporting router and the destination device. In some instances, the next hop address matches the address of the destination device, so the generator determines that the exporting router is directly connected to the destination device. Therefore, the generator does not indicate a separate next hop device in the topology at block 218. In instances where the AS numbers are different as determined at block 214, the next hop address may be associated with a gateway router of a service provider that facilitates the WAN traffic. In such instances, the generator may indicate the gateway router in the topology or may indicate the router as part of a WAN as illustrated in FIG. 1.

The generator indicates the source, destination, router, and next hop router devices in the topology (218). The generator uses the information determined above to indicate or update a location and type of the devices in the topology. The generator may use the device types inferred from the communication protocol to indicate whether the source device is a host, router, switch, database, storage system, etc. If the subnet addresses are the same, the generator indicates that the devices are within the same subnet in the topology. Alternatively, if the subnet address are different, the generator locates the devices within the different, corresponding subnets in the topology. Similarly, if the AS numbers are different, the generator may indicate a WAN in the topology that occurs between the source and destination devices. The location of the WAN may be before or after the exporting router and the next hop router. The generator may determine the location based on the IP addresses of the exporting router or the next hop router in comparison to the IP addresses of the source or destination devices. For example, if the exporting router's and the source device's IP addresses are similar, i.e. both begin with “192.168.X.X”, the generator determines that the WAN is located between the next hop router and the destination device; whereas, if the addresses are dissimilar, the generator may determine that the WAN is located between the source device and the routers. In instances where the next hop router is determined to be part of a service provider's network, the generator may indicate that the exporting router is directly connected to the WAN. In some implementations, the flow data retrieved at block 202 may include flow data from networks on either end of the WAN. As the flow data from both networks is analyzed, the generator can identify the endpoints of the WAN and determine, using the next hop addresses, the routers of a service provider's network that are used to transmit traffic between the networks.

The locations of the devices in the topology may be updated as additional records in the flow data are processed. For example, the location of the WAN may change as additional relationships are determined, such as which routers that are connected to the WAN. Furthermore, the generator may identify additional devices that are connected to the routers or may identify additional intervening network devices between a source and destination device pair. To indicate the devices or update their location, the generator may modify a graph data structure by adding or removing nodes, modifying edges which connect the nodes, adding additional information such as device type in the nodes, etc.

After indicating the devices in the topology, the generator determines whether there is an additional record (220). If there is an additional record, the generator selects the record (204). If there is not an additional record, the process ends.

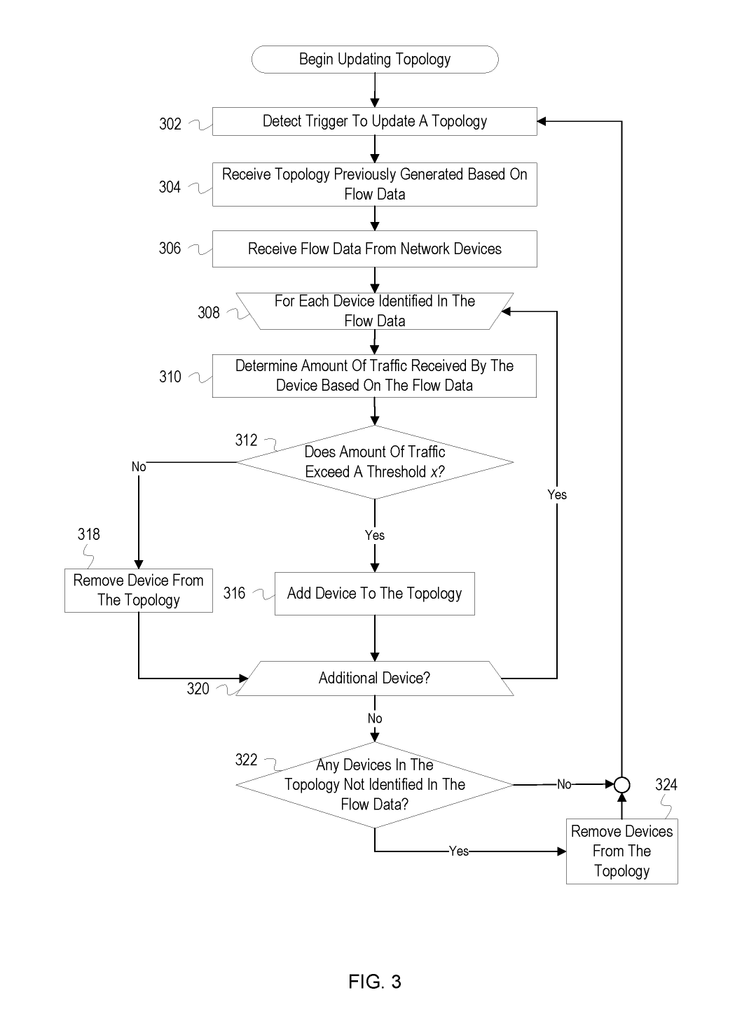

FIG. 3 depicts a flow diagram of example operations for updating a network topology based on flow data. FIG. 3 refers to a topology generator as performing the operations for each of reading and consistency with FIG. 1 even though identification of program code can vary by developer, language, platform, etc.

The topology generator (“generator”) detects a trigger to update a topology (302). As more flow data is captured from a network, the flow data may be analyzed to update a previously determined topology to reflect a current status of devices in a network. For example, the additional flow data may reflect that a device is no longer in a network or that a new device or connections have been added. The trigger to update the topology may be based on receiving additional flow data. For example, the generator may be configured to update the topology once a specified amount of flow data has been received or as flow data is received from flow data collectors or network devices. Additionally, the trigger may be the expiration of a time period such as the last minute, hour, day, etc., or the trigger may be detection of failure of a network device or addition of a network device to a network. Furthermore, the trigger may be the receipt of an indication of a time period or specified device.

After detecting the trigger to update the topology, the generator retrieves the topology previously generated based on flow data (304), and the generator retrieves flow data from network devices (306). The previously generated topology may be maintained in memory of a system executing the generator program code or may be retrieved from a configured storage location. The generator may request flow data from one or more flow data collectors or may retrieve flow data from a database. The generator may retrieve flow data from a time period corresponding to the trigger time period, a time which the topology was previously updated, or a timestamp associated with the last flow data record processed by the generator. Additionally, the generator may retrieve flow data related to a time period corresponding to a network issue or flow data related to a specified device.

The generator begins operations for each device identified in the flow data (308). The generator analyzes the received flow data to identify the devices. The generator may identify the devices by determining the unique IP addresses indicated in the flow data. The generator may iterate through each record in the flow data and extract device identifiers from the source, destination, exporting router, and next hop data fields and add the identifiers to a list if the identifiers are not already indicated in the list. The generator may perform the operations described below each time a unique device identifier is encountered in a record or may iterate over the list once analysis of the flow data is complete. The device currently being iterated over is hereinafter referred to as “the selected device.”

The generator determines an amount of traffic encountered by the selected device based on the flow data (310). To determine the amount of traffic, the generator sums traffic amounts associated with the selected device in the flow data. Traffic associated with the selected device is traffic that was received or transmitted by the selected device. Also, the traffic may include traffic that was routed by or that flowed through the selected device. For example, the selected device may have received 10 megabytes (MB) of traffic, transmitted 20 MB, and routed 5 MB for a total amount of 35 MB encountered by the selected device. The generator may search the flow data with an identifier for the selected device to identify records that indicate the selected device as a source or destination of network traffic or records which were exported by the selected device (i.e., records that indicate traffic routed by the selected device). The generator may then sum the amounts of data indicated by each of the records.

The generator determines if the amount of network traffic exceeds a threshold x (312). The threshold x is a configured value that indicates a threshold amount of network traffic to be encountered by a device for inclusion in the topology. The threshold may be used to create topologies that indicate high traffic devices, low traffic devices, etc. For example, the threshold may be used to create a topology with devices that encounter at least one gigabyte of traffic or a topology with devices that encountered less than 10 MB of traffic. Such topologies may be used to identify over-utilized or under-utilized devices in a network.

If the amount of traffic for the selected device exceeds the threshold, the generator adds the device to the topology (316). The generator adds the selected device to the topology in a manner similar to that described at block 214 of FIG. 2. If the selected device is already indicated in the topology, the generator may instead update the indication of the device with current metrics or attributes such as the amount of traffic encountered by the selected device, timestamp for when the device most recently sent or received traffic, etc.

If the generator determines at block 312 that the amount of traffic does not exceed the threshold, the generator removes the selected device from the topology (318). The generator may first determine whether the selected device is indicated in the topology. If the selected device is indicated, the generator removes the device from the topology. In some implementations, devices that fail to satisfy the threshold may not be excluded or removed from the topology but may be depicted differently from the devices which satisfy the threshold. For example, the devices may be grayed-out, partially transparent, or associated with an icon that indicates failure to satisfy the threshold. The generator may indicate as an attribute in a node for the device that the device failed to satisfy the threshold. The attribute may then be parsed by software to graphically display the device in the manners described above.

After adding or removing the selected device from the topology, the generator determines whether there is an additional device identified in the flow data (320). If there is an additional identified device, the generator selects the next identified device (308).

If there is not an additional network device, the generator determines if any devices in the topology were not identified in the flow data (322). If a device is not identified in the flow data, the generator may determine that the device is no longer operational or is in an idle state and not generating or receiving traffic. To identify such devices, the generator compares a list of devices in the topology to the list of devices identified in the flow data at block 308.

If there are devices in the topology that were not identified in the flow data, the generator removes the devices from the topology (324). The generator is configured to remove idle or non-operational devices from the topology so that the topology reflects a current state of the network rather than depicting inactive devices. The generator may delete the devices from the data structure representing the topology or may change the graphical depiction or modify attributes in a node for the devices to indicate that the devices are not active.

After removing the devices from the topology (324) or after determining that all devices in the topology were identified in the flow data (322), the generator waits until another trigger to update the topology is detected.

FIG. 4 depicts example topologies generated based on filtered flow data. FIG. 4 depicts three topologies: topology 402, time-based topology 406, and device-based topology 411. The topology 402 is based on flow data 401. The flow data 401 includes flow data exported by multiple network devices in a network. The time-based topology 406 is based on time period flow data 405. The time period flow data 405 is a subset of the flow data 401 that includes records from a specified time period. The device-based topology 411 is based on device flow data 410. The device flow data 410 is a subset of the flow data 401 that includes records corresponding to a specified network device, “Router 2” in the illustration of FIG. 4. The topologies and versions of the flow data 401 may be generated by a topology generator (not depicted) such as the topology generator 115 described in FIG. 1.

The subsets of the flow data 401 (the time period flow data 405 and the device flow data 410) may be created by filtering the flow data 401 with a query. For example, to create the time period flow data 405, the flow data 401 may be queried to extract flow records from a specified time period based on timestamps associated with the flow records (not depicted). As an additional example, the device flow data 410 may be created by querying the flow data 401 with an identifier for the Router 2.

The time-based topology 406 and the device-based topology 411 may be used for targeted root cause analysis of network issues. For example, the time-based topology 406 may be used to identify devices that were active within a time period in which a network issue occurred. Since the topology 402 includes flow data outside the time period, the topology 402 may depict devices that were inactive during the network issue and, therefore, likely did not contribute or cause the network issue. By using the time period flow data 405, the time-based topology 406 is more likely to depict those devices which may have contributed to the network issue. Similarly, the device-based topology 411 may be used to aid root cause analysis for a particular part of a network or a particular device. For example, the device flow data 410 may be used to identify network issues occurring at devices connected to the Router 2 or at the Router 2 itself. Since the device-based topology 411 is limited to depicting devices which communicate with or pass traffic through the Router 2, a problematic device may be more easily identified from the device-based topology 411 as opposed to the topology 402 which may include extraneous devices. In some instances, instead of a specified device, the flow data 401 may be filtered to include flow records from devices within an IP address range, devices within a subnet, devices within an AS, etc.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 206 and 208 of FIG. 2 can be performed in parallel or concurrently. With respect to FIG. 3, block 318 is not necessary in instances where the selected device is not indicated in the topology. Similarly, block 316 is not necessary in instances where the selected device is already indicated in the topology. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Some operations above iterate through sets of items, such as network devices or flow records. In some implementations, network devices may be iterated over in an order based on the amount of flow data captured, and flow data may be iterated over based on a timestamp. Also, the number of iterations for loop operations may vary. For example, only a subset of network devices in a network or flow records may be iterated over. Additionally, a loop may not iterate for each network device or flow record in flow data. For example, a loop may exit once a number of flow records have been analyzed or once a number of network devices have been determined.

The variations described above do not encompass all possible variations, implementations, or embodiments of the present disclosure. Other variations, modifications, additions, and improvements are possible.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

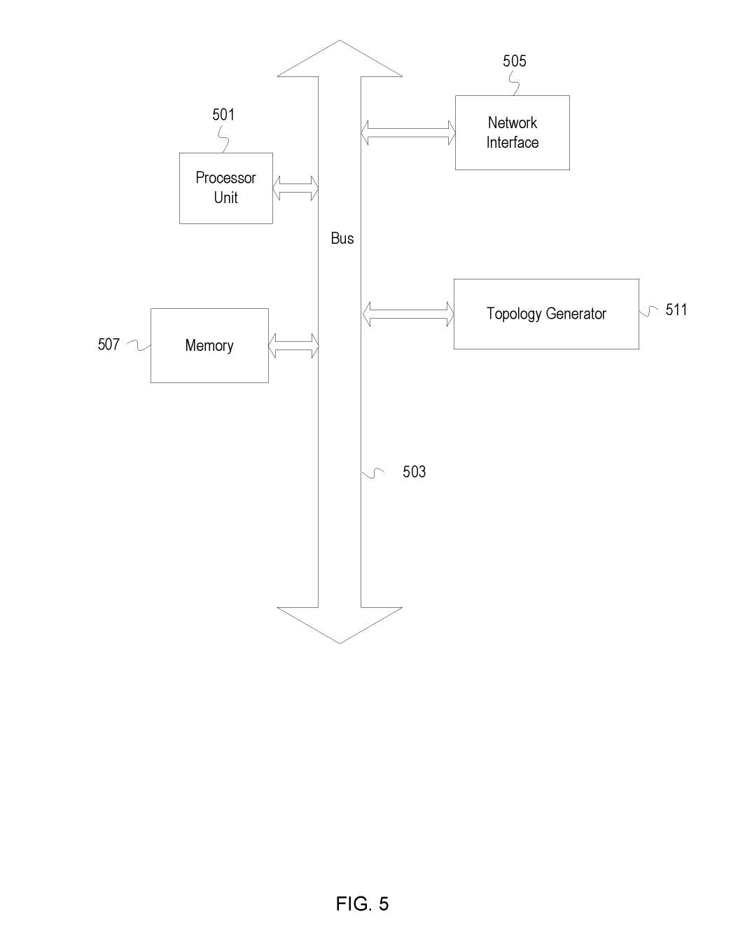

FIG. 5 depicts an example computer system with a topology generator. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes the topology generator 511. The topology generator 511 generates a network topology based on analysis of flow data received from network devices. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for determining a network topology based on flow data as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
retrieving first network traffic data which indicates traffic occurring in a first time period; and
in response to identifying a first indication of traffic between a first device and a second device in the first network traffic data,
identifying a third device which captured the first indication of traffic;
determining that a network connection between the first device and the second device is facilitated by at least the third device;
determining a device type for the first device and a device type for the second device based, at least in part, on a communication protocol identified in the first indication of traffic; and
indicating the first device and the second device in a first topology in accordance with the device types and indicating the third device and the network connection in the first topology.

2. The method of claim 1 further comprising:
in response to receiving second network traffic data which indicates traffic occurring in a second time period, updating the first topology based, at least in part, on the second network traffic data, wherein updating the first topology comprises:
determining that the first device did not generate traffic during the second time period based, at least in part, on the second network traffic data;
in response to determining that the first device did not generate traffic during the second time period, removing an indication of the first device from the first topology; and
in response to determining that a fourth device identified in the second network traffic data is not indicated in the first topology, indicating the fourth device in the first topology.

3. The method of claim 2, wherein indicating the fourth device in the first topology is also in response to determining that an amount of network traffic generated by the fourth device during the second time period exceeds a threshold.

4. The method of claim 2 further comprising:
determining that an amount of network traffic generated by a fifth device during the second time period is below a threshold; and
in response to determining that the amount of network traffic generated by the fifth device is below the threshold, indicating the fifth device in the first topology along with an indication that the fifth device should be graphically depicted differently from devices which exceed the threshold.

5. The method of claim 1 further comprising:
in response to receiving an indication of a fourth device,
identifying a subset of the first network traffic data that is associated with the fourth device;
determining a set of devices connected to the fourth device based, at least in part, on the subset of the first network traffic data;
indicating the fourth device, the set of devices, and connections there between in a second topology; and
supplying the second topology for analysis of issues occurring in relation to the fourth device.

6. The method of claim 1 further comprising supplying the first topology for root cause analysis of a network issue, wherein the first time period corresponds to an occurrence of the network issue.

7. The method of claim 1 further comprising:
identifying a first network identifier associated with the first device and a second network identifier associated with the second device; and
in response to determining that the first network identifier and the second network identifier are different, indicating in the first topology that the network connection between the first device and the second device includes wide area network traffic.

8. The method of claim 1 further comprising:
identifying a fourth device in the first indication of traffic which further facilitates the network connection between the first device and the second device; and
updating the first topology to indicate that the network connection between the first device and the second device includes both the third device and the fourth device.

9. The method of claim 1, wherein indicating the first device and the second device in the first topology in accordance with the device types and indicating the third device and the network connection in the first topology comprises:
generating a first node for the first device, a second node for the second device, and a third node for the third device in a graph data structure;
indicating the device type of the first device in the first node and the device type of the second device in the second node; and
generating a first edge between the first node and the third node and a second edge between the third node and the second node to indicate the network connection.

10. One or more non-transitory machine-readable media comprising program code for generating a network topology with network traffic data, the program code to:
retrieve first network traffic data which indicates traffic occurring in a first time period; and
in response to identifying a first indication of traffic between a first device and a second device in the first network traffic data,
identify a third device which captured the first indication of traffic;
determine that a network connection between the first device and the second device is facilitated by at least the third device;
determine a device type for the first device and a device type for the second device based, at least in part, on a communication protocol identified in the first indication of traffic; and
indicate the first device and the second device in a topology in accordance with the device types and indicate the third device and the network connection in the topology.

11. The non-transitory machine-readable media of claim 10 further comprising program code to:
in response to receiving second network traffic data which indicates traffic occurring in a second time period, update the topology based, at least in part, on the second network traffic data, wherein the program code to update the topology comprises program code to:
determine that the first device did not generate traffic during the second time period based, at least in part, on the second network traffic data;
in response to a determination that the first device did not generate traffic during the second time period, remove an indication of the first device from the topology; and
in response to a determination that a fourth device identified in the second network traffic data is not indicated in the topology, indicate the fourth device in the topology.

12. An apparatus comprising:
a processor; and
a machine-readable medium having program code executable by the processor to cause the apparatus to:
retrieve first network traffic data which indicates traffic occurring in a first time period; and
in response to identifying a first indication of traffic between a first device and a second device in the first network traffic data, identify a third device which captured the first indication of traffic;
determine that a network connection between the first device and the second device is facilitated by at least the third device;
determine a device type for the first device and a device type for the second device based, at least in part, on a communication protocol identified in the first indication of traffic; and
indicate the first device and the second device in a first topology in accordance with the device types and indicate the third device and the network connection in the first topology.

13. The apparatus of claim 12 further comprising program code executable by the processor to cause the apparatus to:
in response to receiving second network traffic data which indicates traffic occurring in a second time period, update the first topology based, at least in part, on the second network traffic data, wherein the program code executable by the processor to cause the apparatus to update the first topology comprises program code executable by the processor to cause the apparatus to:
determine that the first device did not generate traffic during the second time period based, at least in part, on the second network traffic data;
in response to a determination that the first device did not generate traffic during the second time period, remove an indication of the first device from the first topology; and
in response to a determination that a fourth device identified in the second network traffic data is not indicated in the first topology, indicate the fourth device in the first topology.

14. The apparatus of claim 13, wherein the program code executable by the processor to cause the apparatus to indicate the fourth device in the first topology is also in response to a determination that an amount of network traffic generated by the fourth device during the second time period exceeds a threshold.

15. The apparatus of claim 13 further comprising program code executable by the processor to cause the apparatus to:
determine whether an amount of network traffic generated by a fifth device during the second time period is below a threshold; and
in response to determining that the amount of network traffic generated by the fifth device is below the threshold, indicate the fifth device in the first topology along with an indication that the fifth device should be graphically depicted differently from devices which exceed the threshold.

16. The apparatus of claim 12 further comprising program code executable by the processor to cause the apparatus to:
in response to receiving an indication of a fourth device,
identify a subset of the first network traffic data that is associated with the fourth device;
determine a set of devices connected to the fourth device based, at least in part, on the subset of the first network traffic data;
indicate the fourth device, the set of devices, and connections there between in a second topology; and
supply the second topology for analysis of issues occurring in relation to the fourth device.

17. The apparatus of claim 12 further comprising program code executable by the processor to cause the apparatus to supply the first topology for root cause analysis of a network issue, wherein the first time period corresponds to an occurrence of the network issue.

18. The apparatus of claim 12 further comprising program code executable by the processor to cause the apparatus to:
identify a first network identifier associated with the first device and a second network identifier associated with the second device; and
in response to determining that the first network identifier and the second network identifier are different, indicate in the first topology that the network connection between the first device and the second device includes wide area network traffic.

19. The apparatus of claim 12 further comprising program code executable by the processor to cause the apparatus to:
identify a fourth device in the first indication of traffic which further facilitates the network connection between the first device and the second device; and
update the first topology to indicate that the network connection between the first device and the second device includes both the third device and the fourth device.

20. The apparatus of claim 12, wherein the program code executable by the processor to cause the apparatus to indicate the first device and the second device in the first topology in accordance with the device types and indicate the third device and the network connection in the first topology comprises program code executable by the processor to cause the apparatus to:
generate a first node for the first device, a second node for the second device, and a third node for the third device in a graph data structure;
indicate the device type of the first device in the first node and the device type of the second device in the second node; and
generate a first edge between the first node and the third node and a second edge between the third node and the second node to indicate the network connection.
